(19) United States
(12) Patent Application Publication
(10) Pub. No.: US 2026/0001100 A1
(43) Pub. Date: Jan. 1, 2026

(54) METHOD FOR PRODUCING VIBRATION DAMPING STRUCTURE BODY

(71) Applicants: MAZDA MOTOR CORPORATION, Hiroshima (JP); NIHON TOKUSHU TORYO CO., LTD., Tokyo (JP)

(72) Inventors: Hiroyuki NAGATOMO, Hiroshima (JP); Ryuji NONAKA, Hiroshima (JP); Yuji MIYOSHI, Hiroshima (JP); Shinichi OHSHIMA, Hiroshima (JP); Hiroyuki HIRAO, Hiroshima (JP); Akira HOTTA, Hiroshima (JP)

(73) Assignees: MAZDA MOTOR CORPORATION, Hiroshima (JP); NIHON TOKUSHU TORYO CO., LTD., Tokyo (JP)

(21) Appl. No.: 19/237,142

(22) Filed: Jun. 13, 2025

(30) Foreign Application Priority Data
Jun. 27, 2024 (JP) 2024-104300

(51) Int. Cl. B05D 7/14; B05D 3/00

(52) U.S. Cl. CPC B05D 7/14; B05D 3/007; B05D 2502/00

(57) ABSTRACT

A method for producing a vibration damping structure body includes: a first step of providing a first resin on a surface of a panel member; a second step of curing a surface of the first resin by heating; a third step of providing a second resin to be a restriction layer on the surface of the first resin; and a fourth step of heating the first resin and the second resin thereby curing the second resin to form the restriction layer and causing the first resin to foam internally to form the vibration damper.

### FIELD OF INVENTION

The present invention relates to a method for producing a vibration damping structure body for a panel member such as a floor panel of a vehicle.

### BACKGROUND ART

There have been various structures proposed to reduce vibration of a floor panel that constitutes a floor of a vehicle during running of the vehicle. For example, as disclosed in Patent Publication No. 2006-315627, there has been known a structure in which a vibration damper made of, e.g., an asphalt-based resin capable of damping vibration is applied on a part of the floor panel with a lower rigidity that is easily vibrated.

In the structure including the vibration damper applied on the floor panel, the vibration damper converts vibration energy transmitted from a frame of a vehicle body to the floor panel during running of the vehicle into, e.g., heat energy, so that vibration of the floor panel is reduced. Consequently, ride quality and NVH performance, i.e., performance of reducing noise, vibration, and harshness (roughness and uncomfortableness) are improved.

It is indispensable for further enhancement of a vibration damping effect of the structure described above to increase an amount of the vibration damper; thus, there is room for improvement in the enhancement of the vibration damping effect for production cost and the weight of the vibration damper.

### SUMMARY OF THE INVENTION

The present invention has been made in view of the above-mentioned circumstances, and an object thereof is to provide a method for producing a vibration damping structure body that can enhance the vibration damping effect while preventing excessive increase in the production cost and the weight of the vibration damper.

A method of the present invention for producing a vibration damping structure body including: a panel member; a vibration damper made of a first resin to cure superficially and foam internally by heating, and adhered to at least one surface of the panel member; a restriction layer that is made of a thermosetting second resin, less deformable than the vibration damper, and adhered to a surface of the opposite side of the vibration damper from the panel member, includes: a first step of providing the first resin on the at least one surface of the panel member; a second step of curing a surface of the first resin by heating; a third step of providing the second resin on the surface of the first resin; and a fourth step of heating the first resin and the second resin thereby curing the second resin to form the restriction layer and causing the first resin to foam internally to form the vibration damper.

### BRIEF DESCRIPTION OF THE DRAWINGS

FIG. 1 is a perspective view of a whole vibration damping structure body with a partial omission, produced by a method for producing a vibration damping structure body according to an embodiment of the present invention.

FIG. 2 is a flowchart of a procedure of the method for producing the vibration damping structure body according to the embodiment of the present invention.

FIG. 3 is a table showing exemplary vibration damping structure bodies for examining a coat thickness increasing effect by the producing method according to the embodiment, in which I to III represent structures as examples, which have one, two, or three layers of a vibration damper and a restriction layer adhered to an uppermost layer of the vibration damper, and IV to VI represent structures as comparative examples, which have one, two, or three layers of the vibration damper only without the restriction layer.

FIG. 4 is a graph showing a relationship between the number of layers of the vibration damper and an entire coat thickness of the vibration damper and the restriction layer for each of the structures I to VI in FIG. 3.

FIG. 5A is an illustration representing a storage process of strain energy at a corner of a protruding part and a corner of a recessed part of the vibration damper according to the embodiment in FIG. 1 in response to vibration, showing a state before the vibration.

FIG. 5B is an illustration representing the storage process of strain energy at the corner of the protruding part and the corner of the recessed part of the vibration damper according to the embodiment in FIG. 1 in response to vibration, showing a state during the vibration where the strain energy is stored at the corners.

FIG. 6 is a perspective view of a configuration in which the vibration damping structure body according to the embodiment is used for a floor panel of a vehicle.

FIG. 7 is an enlarged perspective view of a configuration in which the vibration damping structure body according to the embodiment is used for a spare tire pan as a curved part of the floor panel of the vehicle, showing that a plurality of vibration dampers extends radially.

FIG. 8 is an enlarged perspective view of a configuration in which the vibration damping structure body according to the embodiment is used for a spare tire pan having an opening as the curved part of the floor panel of the vehicle.

FIG. 9 is an enlarged plan view of a plurality of vibration dampers extending radially from a ridgeline around the opening in FIG. 8.

FIG. 10A is an illustration for describing shear deformation of the vibration damper in accordance with bending deformation of a panel member in FIG. 1 due to vibration, showing that no shear deformation occurs in a comparative example that does not include a restriction layer.

FIG. 10B is an illustration for describing shear deformation of the vibration damper in accordance with bending deformation of the panel member in FIG. 1 due to vibration, showing that shear deformation occurs in the embodiment due to restriction of the vibration damper by the restriction layer.

FIG. 11A is an illustration indicating distribution of strain energy stored in the vibration damper in accordance with bending deformation of the panel member in FIG. 1, showing that strain energy stored in the vibration damper is low in the comparative example that does not include the restriction layer.

FIG. 11B is an illustration indicating distribution of strain energy stored in the vibration damper in accordance with bending deformation of the panel member in FIG. 1, showing that strain energy stored in the vibration damper is high in the embodiment due to the restriction of the vibration damper by the restriction layer.

FIG. 12 is an illustration schematically showing a test sample as an example in which the vibration damper is applied longitudinally on the panel member.

FIG. 13 is a graph showing a relationship between inertances and frequencies of vibration waves due to vibration to vibration damping structure bodies in which the test sample as the example in FIG. 12 is combined with structures I to VI in FIG. 3, and vibration to a structure X including the panel member only.

FIG. 14 is an illustration schematically showing a structure as a comparative example in which the vibration damper is applied laterally on the panel member.

FIG. 15 is a graph showing a relationship between inertances and frequencies of vibration waves due to vibration to vibration damping structure bodies in which the test sample as the comparative example in FIG. 14 is combined with the structure bodies I to VI in FIG. 3, and vibration to the structure X including the panel member only.

FIG. 16 is an illustration schematically showing an application direction of the vibration damper according to the embodiment and two bending directions thereof.

### DETAILED DESCRIPTION

Hereinafter, a method for producing a vibration damping structure body according to an embodiment of the present invention will be described with reference to the accompanying drawings.

### Basic Configuration of Vibration Damping Structure Body

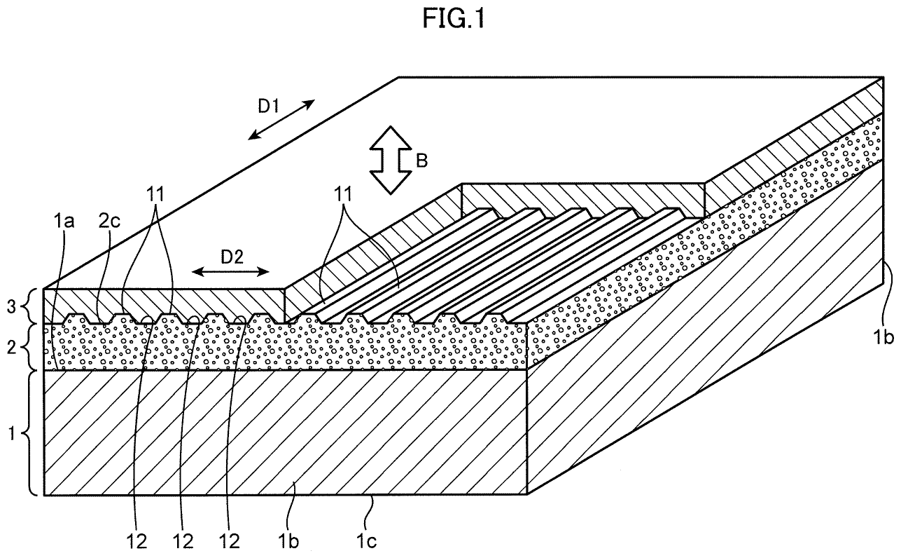

First, a vibration damping structure body produced by the producing method according to the embodiment will be described. The vibration damping structure body shown in FIG. 1 includes a panel member 1 in shape of a plate, a vibration damper 2 adhered by, e.g., application, to at least one surface of the panel member 1, in the embodiment, adhered to an upper surface 1a, and a restriction layer 3 adhered to a surface of the opposite side of the vibration damper 2 from the panel member 1, in the embodiment, adhered to an upper surface 2c. The vibration damping structure body has a three-layered structure in which the panel member 1, the vibration damper 2, and the restriction layer 3 are layered one after another and connected with each other. The vibration damper 2 and the restriction layer 3 may be adhered to a lower surface 1c of the panel member 1, or may be adhered to both of the upper surface 1a and the lower surface 1c of the panel member 1.

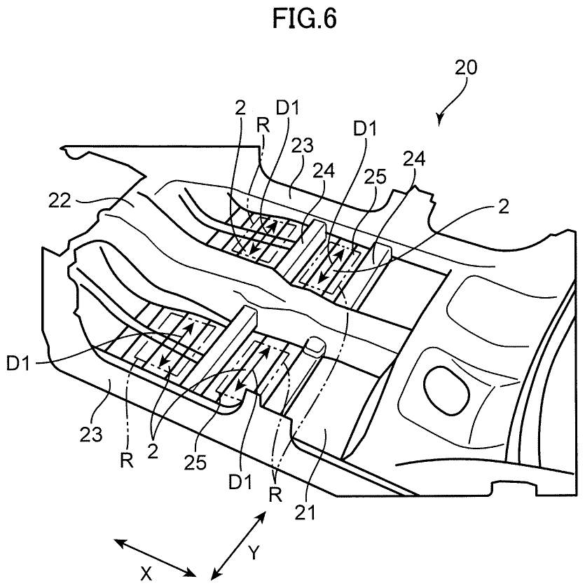

The panel member 1 is a plate member attached to a part to receive external vibration, and is used as, e.g., a floor panel 21 (see FIGS. 6 to 8) that constitutes a floor of a vehicle as described later. The panel member 1 is used with at least its opposite ends 1b being fixed, preferably, with its surrounding ends being fixed. The material of the panel member 1 is not particularly limited in the present invention. In a case where the panel member 1 is used as the floor panel 21 of the vehicle, the panel member 1 may be a thin steel plate.

The vibration damper 2 is adhered to the upper surface 1a of the panel member 1 by, e.g., application or pasting. The vibration damper 2 is made of a first resin to cure superficially and foam internally by heating as described later, the first resin being capable of damping vibration transmitted to the panel member 1. For example, material such as an acrylic emulsion paint is used as the first resin; more specifically, material containing a foaming agent to foam by heating, such as the acrylic emulsion paint, a polyurethane resin paint, an epoxy resin paint, and a vinyl chloride plastisol paint, is used. The vibration damper 2 has a rigidity or an elasticity enough to exert the vibration damping effect; for example, the vibration damper 2 has a Young's modulus of approximately 400 MPa to 700 MPa. The acrylic emulsion paint described above has a Young's modulus of approximately 600 MPa.

As shown in FIG. 1, the vibration damper 2 in the embodiment is made of the first resin to foam internally and cure superficially by heating, the first resin being composed of the acrylic emulsion paint and applied in a certain first direction D1. Thus, the vibration damper 2 has a layer containing bubbles on the upper surface 1a of the panel member 1. The vibration damper 2, which contains the bubbles, stores vibration energy transmitted to the panel member 1 as strain energy to thereby damp the vibration of the panel member 1.

The vibration damper 2 has a plurality of protruding parts 11 and a plurality of recessed parts 12 over the upper surface 1a.

Each of the protruding parts 11 is continuous (extends) along a first direction D1 being a direction in which the vibration damper 2 is to be stretched or compressed in response to application of a bending load B to the panel member 1, specifically, in response to the application of the bending load B caused by external vibration to the panel member 1 with its opposite ends 1b being fixed. The protruding parts 11 are spaced away from each other in a second direction D2 orthogonal to the first direction D1.

Each of the recessed parts 12 is formed between two protruding parts 11 adjacent to each other.

The protruding parts 11 are formed during formation of the vibration damper 2 by: applying the first resin to be the vibration damper 2 such as the acrylic emulsion paint on the upper surface 1a of the panel member 1 so as to extend in the first direction D1 while causing a plurality of nozzles to discharge the first resin; and heating to the first resin (the paint) cause the first resin (the paint) to foam internally and cure superficially. Thus, each of the protruding parts 11 extends continuously in the first direction D1 and has a substantially semicircular cross-section or a substantially rectangular cross-section. On the other hand, the recessed part 12 formed between the two protruding parts 11 adjacent to each other is a groove extending in the first direction D1 and having a shape conforming to opposite surfaces of the two protruding parts 11 adjacent to each other.

The restriction layer 3 is adhered by, e.g., application to a surface of the opposite side of the vibration damper 2 from the panel member 1, in the embodiment, adhered to the upper surface 2c.

The restriction layer 3 is made of a thermosetting second resin less deformable than the vibration damper 2, e.g., an acrylic resin used for clear coating of a surface of the vehicle body in vehicle manufacturing. The restriction layer 3 is less deformable (e.g., has a higher rigidity or a higher elasticity) than the vibration damper 2; for example, the restriction layer 3 has a Young's modulus of approximately 1300 MPa to 2000 MPa. The acrylic resin described above has a high Young's modulus of approximately 1650 MPa. Thus, the restriction layer 3, which has an elasticity higher than that of the vibration damper 2, is resistant to bending deformation, or tensile deformation and compressive deformation.

The restriction layer 3 fits at least in the recessed part 12. Thus, the restriction layer 3 fitting in the recessed part 12 can restrict the protruding parts 11 on both sides of the recessed part 12.

In the embodiment, as shown in FIG. 1, the restriction layer 3 covers the protruding parts 11 and the recessed parts 12 of the vibration damper 2 entirely.

### Description of Method for Producing Vibration Damping Structure Body

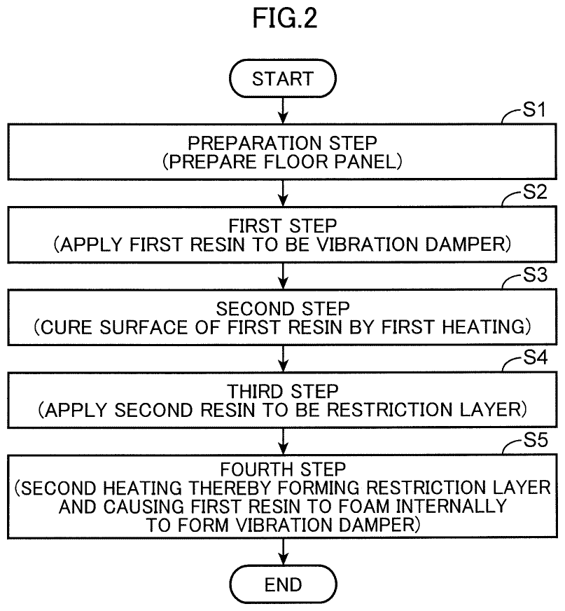

In the producing method according to the embodiment of the present invention, the vibration damping structure body shown in FIG. 1 is produced by a procedure represented by a flowchart shown in FIG. 2.

First, in a preparation step S1, a floor panel 21 (see FIGS. 6 to 8) that constitutes a floor of a vehicle is prepared as the panel member 1 for the vibration damping structure body.

Next, in a first step S2, the first resin to be the vibration damper 2 such as an acrylic emulsion paint is applied or pasted on an upper surface of the floor panel 21.

Next, in a second step S3, a surface of the first resin is cured by heating. In this step, the first resin may foam to some extent (prefoam) with the cure of the surface thereof. The heating in the second step S3 and a fourth step S5 described later is performed in, e.g., an already-existing coating drying furnace for vehicle manufacturing.

Next, in a third step S4, the second resin to be the restriction layer 3 such as an acrylic resin is applied on the first resin. The second resin such as the acrylic resin is applied to have a coat thickness of approximately 20 μm to 30 μm for clear coating.

Then, in the fourth step S5, the first resin and the second resin are heated. And thus, the second resin is cured to form the restriction layer 3, and the first resin is foamed internally to form the vibration damper 2.

In the producing method, in the second step S3, the surface of the first resin to be the vibration damper 2 is cured by heating in advance; then, in the third step S4, the second resin to be the restriction layer 3 is placed on the first resin to cover the first resin from above; and thereafter, in the fourth step S5, the first resin and the second resin are heated to form the vibration damper 2 and the restriction layer 3.

Specifically, the internal foaming of the first resin is promoted by reheating the first resin in the fourth step S5 after covering the surface of the first resin with the second resin in the third step S4, so that the coat thickness of the formed vibration damper 2 can be increased. Thus, the vibration damping effect by the vibration damping structure body can be enhanced without excessive increase in the production cost and the weight of the vibration damper.

In the producing method, preferably, the second resin to be the restriction layer 3 is made of clear coating material. This configuration enables conventional vehicle manufacturing equipment that performs clear coating to create the vibration damping structure body described above.

In the producing method, preferably, in the fourth step S5, the first resin is heated at a temperature higher than a heating temperature in the second step S3. This configuration ensures that the first resin foams internally and ensures increase in the coat thickness of the vibration damper 2.

For example, in the second step S3, first heating of the first resin is performed at a heating temperature of approximately 110° C. to 120° C. for about 10 to 60 minutes to cure the surface of the first resin; then, in the third step S4, the second resin to be the restriction layer 3 is applied to cover the first resin from above; then, in the fourth step S5, second heating of the first resin is performed at a heating temperature of approximately 130° C. to 160° C. for about 15 to 60 minutes to cause the first resin to foam internally. This configuration enables the vibration damper 2 to have a sufficient coat thickness.

### Verification of Coat Thickness Increasing Effect

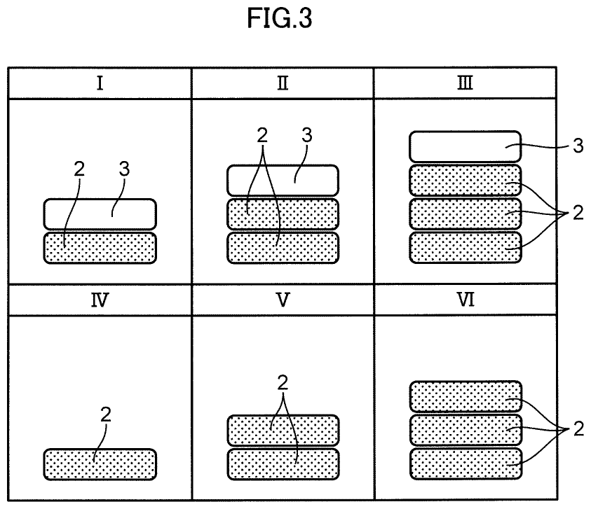

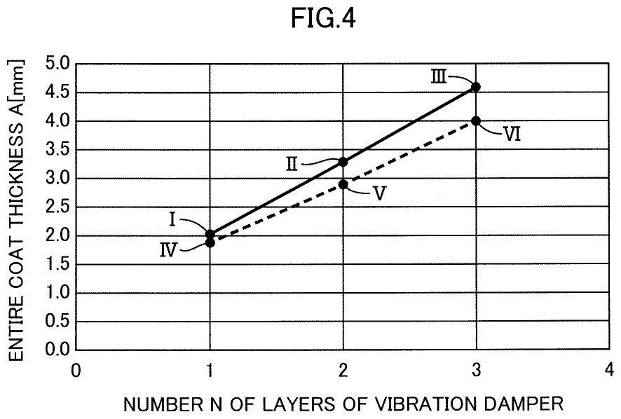

Next, a coat thickness increasing effect on the vibration damper 2 by the producing method will be described with reference to FIGS. 3 and 4.

FIG. 3 is a table showing exemplary vibration damping structure bodies for examining the coat thickness increasing effect by the producing method according to the embodiment, in which I to III represent structures as examples, which have one, two, or three layers of the vibration damper 2 and the restriction layer 3 adhered to an uppermost layer of the vibration damper 2, and IV to VI represent structures as comparative examples, which have one, two, or three layers of the vibration damper 2 only without the restriction layer.

FIG. 4 is a graph showing a relationship between the number N of layers of the vibration damper 2 and an entire coat thickness A of the vibration damper 2 and the restriction layer 3 for each of the structures I to VI in FIG. 3.

The graph in FIG. 4 clearly shows that each of the structures I to III as the examples in which the restriction layer 3 is adhered to the outermost layer of the vibration damper 2 has an increased entire coat thickness A of the vibration damper 2 and the restriction layer 3, with respect to the corresponding one of the structures IV to VI that has the same number N of the layers of the vibration damper 2 as the comparative examples without the restriction layer 3.

The increase in the entire coat thickness A for each of the structures I to III is apparently ascribed to the promotion of the internal foaming of the first resin by reheating the first resin in the fourth step S5 after covering the surface of the first resin to be the vibration damper 2 with the second resin to be the restriction layer 3 in the third step S4.

In the graph in FIG. 4, increases in the entire coat thicknesses A of the structures I to III with respect to the structures IV to VI show that the increases in the coat thicknesses A get larger as the number N of layers in the vibration damper 2 increases.

The results shown by the graph in FIG. 4 indicates that, in the producing method shown in FIG. 2, preferably, in the first step, two or more layers of the first resin are provided, and, in the third step, the second resin is placed on the surface of the outermost layer of the first resin.

Thus, covering the surface of the outermost layer of the first resin with the second resin in the third step causes the heating of the first resin in the subsequent fourth step to promote the internal foaming of all the layers of the first resin, so that the coat thickness of the formed vibration damper can be increased. Thus, the coat thickness increasing effect can be exerted.

### Enhancement of Vibration Damping Effect Due to Formation of Protruding Parts 11

Formation of the protruding parts 11 on the vibration damper 2 as shown in FIG. 1 in the vibration damping structure body produced as described above can enhance the vibration damping effect. A way for forming the protruding parts 11 is as follows.

In the forming way, the first resin is applied on the panel member 1 to extend in shape of a strip so as to form a plurality of protruding parts 11 on the surface of the first resin to be the vibration damper 2, in the first step S2 shown in FIG. 2. Specifically, the protruding parts 11 are formed by applying the first resin to be the vibration damper 2 such as the acrylic emulsion paint on the upper surface 1a of the panel member 1 so as to extend in the certain first direction D1 while causing a plurality of nozzles to discharge the first resin.

Then, in the second step S3, the protruding parts 11 are cured by heating.

Then, in the third step S4, the second resin to be the restriction layer 3 is applied to fit in a recessed part 12 between protruding parts 11 adjacent to each other.

Subsequently, in the fourth step S5, the second resin is heated and cured to form the restriction layer 3, which restricts the protruding parts 11.

Thus, the restriction layer 3 restricts the protruding parts 11 of the vibration damper 2 to each other, so that the restricting effect by the restriction layer 3 on the vibration damper 2 is enhanced, and the vibration damping effect is further enhanced.

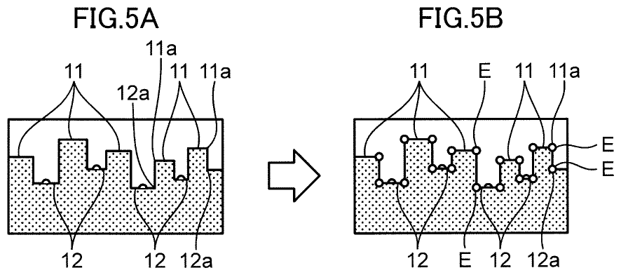

In the vibration damping structure body shown in FIG. 1, each of the protruding parts 11 of the vibration damper 2 is continuous in the first direction D1 being the direction in which the vibration damper 2 is to be stretched and deformed in response to the application of the bending load B. In this regard, with reference to FIGS. 5A and 5B schematically showing cross-sections of the vibration damper 2 and the restriction layer 3, no strain energy is stored in the vibration damper 2 in a state before vibration in FIG. 5A, and strain energy is stored in the vibration damper 2 in a state during the vibration in FIG. 5B. Particularly, the highest strain energy E is stored at a corner 11a of a protruding part 11 and a corner 12a of a recessed part 12 of the vibration damper 2. This shows that the vibration damping structure body including the protruding parts 11 restricted by the restriction layer 3 as shown in FIG. 1 exerts a strong vibration damping effect.

In the method for producing the vibration damping structure body according to the embodiment, preferably, the restriction layer 3 covers the protruding parts 11 and the recessed parts 12 of the vibration damper 2 entirely. In this configuration, the restriction layer 3 can integrally and firmly restrict the protruding parts 11, so that the flexural rigidity of the vibration damper 2 is further enhanced. Therefore, the vibration damper 2 stores still higher strain energy, and the vibration damping effect can be further enhanced.

Exemplary Adoption of Producing Method according to Embodiment

The method for producing the vibration damping structure body as shown in FIG. 1 including the vibration damper 2 and the protruding parts 11 formed thereon is available in producing a vibration damping structure body appropriate for vibration damping of a floor panel of a vehicle.

Specifically, in the method for producing the vibration damping structure body above, in the preparation step S1 previous to the first step S2 shown in FIG. 2, a floor panel 21 serving as the panel member 1 in FIG. 1 is prepared, the floor panel 21 constituting a floor of a vehicle shown in FIG. 6 and being fixed to a center frame 22 and side frames 23 of a vehicle body extending in a vehicle longitudinal direction.

The center frame 22 extends in a lower portion of a vehicle body 20 in the vehicle longitudinal direction X at a middle position in the vehicle width direction Y to serve as, for example, a floor tunnel. The side frames 23 extend in the vehicle longitudinal direction X at opposite ends in the vehicle width direction Y to serve as, for example, side sills. The floor panel 21 may be fixed to at least one frame extending in the longitudinal direction. The floor panel 21 may be fixed to a frame at a part of the floor panel 21 other than ends thereof.

In the first step S2, the first resin is applied on the floor panel 21 in an intersection direction intersecting the vehicle longitudinal direction X, e.g., in the vehicle width direction Y as shown in FIG. 6 to form the protruding parts 11 extending in the intersection direction. The subsequent second step S3 to fourth step S5 are as described above.

The floor panel 21 has opposite ends fixed to the frames 22, 23 extending in the vehicle longitudinal direction X. Thus, the floor panel 21 has an enhanced flexural rigidity in the vehicle longitudinal direction X due to a reinforcing effect by the frames 22, 23.

In contrast, flexural rigidity in the intersection direction intersecting the vehicle longitudinal direction X, particularly in the vehicle width direction Y is low because the reinforcing effect by the frames 22, 23 is weak. Accordingly, the floor panel 21 is most likely to be bent and deformed in the vehicle width direction Y when receiving external vibration.

Therefore, in the producing method above, the first resin is applied on the floor panel 21 in the intersection direction intersecting the vehicle longitudinal direction X, e.g., in the vehicle width direction Y as shown in FIG. 6 to form the protruding parts 11 extending in the intersection direction. The protruding parts 11 that are continuous in the intersection direction are restricted by the restriction layer 3 formed in the fourth step S5, so that the rigidity of the vibration damper 2 can be enhanced, and the vibration damper 2 can store strain energy. Consequently, the vibration damping effect can be enhanced.

In the method for producing the vibration damping structure body according to the embodiment, in the first step S2, the first resin is applied in the vehicle width direction Y perpendicularly intersecting the vehicle longitudinal direction X to form the protruding parts 11 extending in the vehicle width direction Y.

For the producing method, the vibration damper 2 extends in the vehicle width direction Y for which the flexural rigidity of the floor panel 21 is the lowest, and the protruding parts 11 are continuous in the vehicle width direction Y, so that the vibration damper 2 can store higher strain energy. Consequently, the vibration damping effect can be further enhanced.

The floor panel 21 is fixed to a plurality of cross members 24 of the vehicle body extending in the vehicle width direction Y and spaced away from each other in the vehicle longitudinal direction X.

The floor panel 21 has a region 25 between the cross members 24, the region serving as a curved part that is curved downward or upward.

The region 25 of the floor panel 21 between the cross members 24, corresponding to the curved part, has a particularly low flexural rigidity; therefore, in this configuration, the vibration damper 2 is formed on the region 25, so that the vibration damper 2 can store higher strain energy. Consequently, the vibration damping effect in the region 25 of the floor panel 21 between the cross members 24 can be enhanced.

Preferably, in the first step S2, the first resin to be the vibration damper 2 is applied on the region 25 between the cross members 24 in the vehicle width direction Y to form the protruding parts 11 extending in the vehicle width direction Y.

As shown in FIG. 6, the vibration damping structure body according to the embodiment includes the vibration damper 2 extending in the region 25 between the cross members 24 in the vehicle width direction Y. The protruding parts 11 extend in the vehicle width direction Y serving as the first direction D1. The region 25 between the cross members 24 has a particularly low flexural rigidity in the vehicle width direction Y; therefore, in this configuration, the first resin is applied on the region 25 in the vehicle width direction Y, so that the vibration damper 2 having the protruding parts 11 extending in the vehicle width direction Y can be formed. Thus, the vibration damper 2 can store still higher strain energy. Consequently, the vibration damping effect in the region 25 between the cross members 24 can be further enhanced.

In the method for producing the vibration damping structure body according to the embodiment, preferably, the vibration damper 2 is placed on a region R of the floor panel 21 below a seat as shown in FIG. 6. The seat placed on the region R includes a driver's seat, a passenger seat, and a rear seat. An occupant easily perceives vibration occurring in the region R of the floor panel 21 below the seat; therefore, in this producing method, the vibration damper 2 is placed on the region R, so that the occupant is less likely to perceive the vibration of the floor panel 21; thus, comfortability is improved.

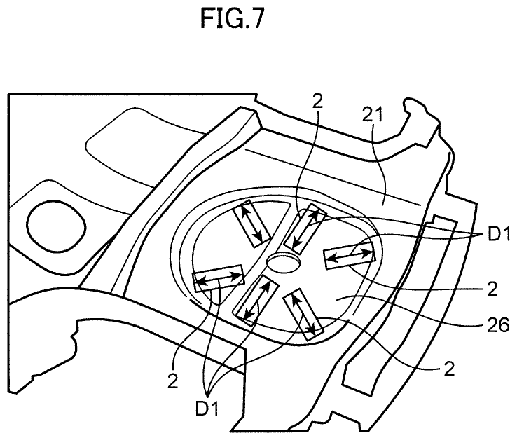

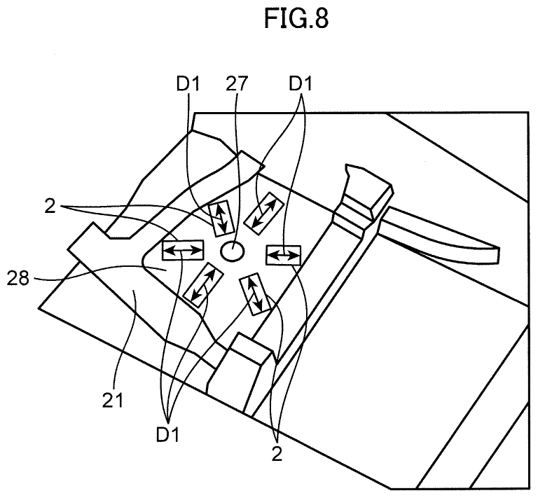

### Description of Application on Spare Tire Pan 26, 28 in FIGS. 7 and 8

In the preparation step S1 previous to the first step S2, as shown in FIGS. 7 and 8, a floor panel 21 that constitutes the floor of the vehicle and has, e.g., a spare tire pan 26, 28 serving as another curved part which is curved downward or upward from the floor panel 21 may be prepared, and, in the first step S2, the first resin to be the vibration damper 2 may be applied on the spare tire pan 26, 28 serving as the curved part.

In a case where the floor panel 21 has the curved part such as the spare tire pan 26, 28 as shown in FIGS. 7 and 8, the curved part has a lower flexural rigidity than a flat part of the floor panel 21, particularly, has a much lower flexural rigidity than a flat part reinforced by the frames 22, 23. Therefore, as described above, the first resin is applied on the spare tire pan 26, 28 serving as the curved part of the floor panel 21 with the lower flexural rigidity to form the vibration damper 2. Thus, the vibration damper 2 having an enhanced rigidity due to the restriction of the protruding parts 11 by the restriction layer 3 as described above can store the strain energy. Consequently, the vibration damping effect can be enhanced.

Preferably, in the first step S2, as shown in FIGS. 7 and 8, the first resin to be the vibration damper 2 is applied on a plurality of areas of the spare tire pan 26, 28, serving as the curved part, spaced away from each other around a center of the spare tire pan 26, 28, serving as the curved part, and extending radially in a centrifugal direction from the center, in a view from one side along an up-down direction, e.g., from an upper side, to form the protruding parts 11 extending in the centrifugal direction.

The spare tire pan 26, 28 has a particularly low flexural rigidity in a direction from the center thereof toward the periphery; therefore, in the producing method, the protruding parts 11 extending in the centrifugal direction are formed as described above, so that vibration damper 2 can store higher strain energy. Consequently, the vibration damping effect can be further enhanced.

In FIGS. 7 and 8, the spare tire pan 26, 28 for housing the spare tire serves as the curved part, i.e., the spare tire pan 26, 28 having a diameter large enough to house the spare tire serves as the curved part. The spare tire pan 26, 28 has a particularly lower flexural rigidity than other parts of the floor panel 21; therefore, the vibration damper 2 is formed on the spare tire pan 26, 28, so that the vibration damper 2 can store the strain energy. Consequently, the vibration damping effect in the spare tire pan 26, 28 can be enhanced.

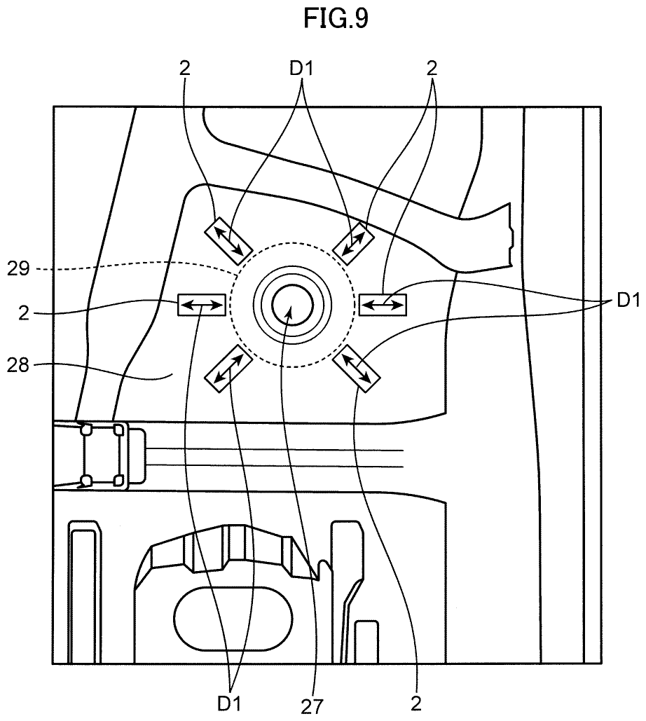

In a case where the spare tire pan 28 has an opening 27 at a center of the spare tire pan 28 as shown in FIG. 8, a plurality of the vibration dampers 2 may be formed to extend radially from a ridgeline 29 around the opening 27 as shown in the enlarged view in FIG. 9.

### Description of Mechanism of Vibration Damping by Vibration Damping Structure Body

Hereinafter, a mechanism of vibration damping by the vibration damping structure body according to the embodiment will be described.

First, a mechanism of increase in the strain energy in the vibration damper 2 by the restriction layer 3 in the vibration damping structure body according to the embodiment will be described.

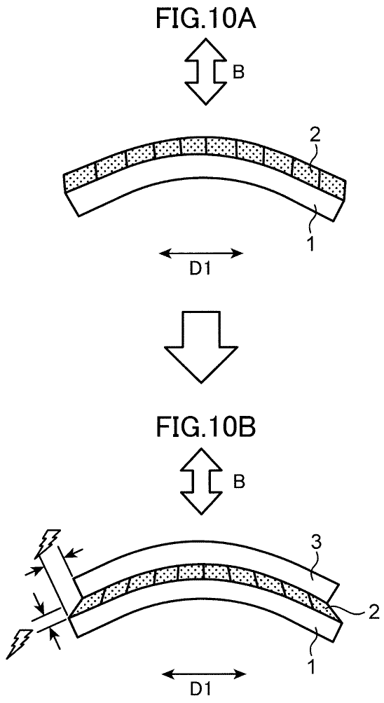

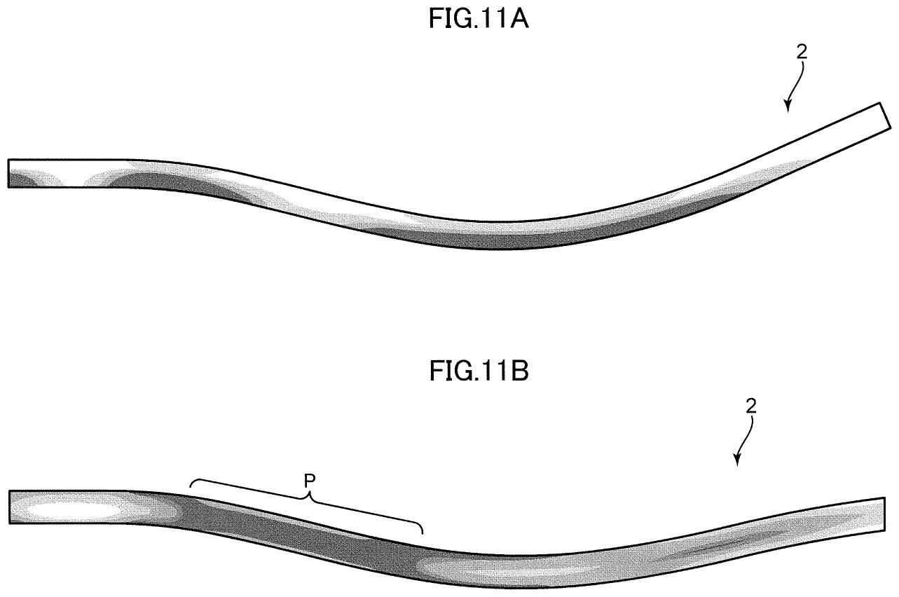

In a structure as a comparative example shown in FIG. 10A in which only the vibration damper 2 is layered on the panel member 1, when the vibration damper 2 is stretched in the first direction D1 in response to application of the bending load B to the panel member 1, the vibration damper 2 is entirely stretched and deformed in accordance with the panel member 1. Therefore, it is considered that the vibration damper 2 stores low strain energy. FIG. 11A indicating distribution of the strain energy stored in the vibration damper 2 in FIG. 10A shows that there are few dark-colored parts representing regions with high strain energy This means that the vibration damper 2 stores low strain energy.

On the other hand, as shown in FIG. 10B, in a structure representing the embodiment in which the vibration damper 2 and the restriction layer 3 are layered on the panel member 1, the restriction layer 3 restricts the vibration damper 2 to prevent the vibration damper 2 from being stretched and deformed in the first direction D1, so that shear deformation, i.e., large deformation in a shear direction can be caused at opposite ends of the vibration damper 2. This enables the vibration damper 2 to store high strain energy. FIG. 11B indicating distribution of the strain energy stored in the vibration damper 2 in FIG. 10B shows that there are more dark-colored parts representing regions with high strain energy, including a part P that is very dark particularly, than FIG. 11A. This means that the vibration damper 2 stores high strain energy.

Next, the vibration damping effect by the vibration damping structure body according to the embodiment will be verified with reference to FIGS. 3, and 12 to 15.

The structures I to VI shown in FIG. 3 are used for vibration damping structure bodies for examining the vibration damping effect. I to III represent structures as examples, which have one, two, or three layers of the vibration damper 2 and the restriction layer 3 adhered to an uppermost layer of the vibration damper 2, and IV to VI represent structures as comparative examples, which have one, two, or three layers of the vibration damper 2 only without the restriction layer 3.

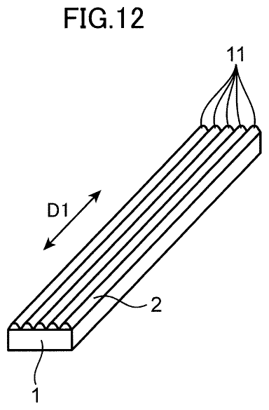

FIG. 12 is an illustration schematically showing a test sample as the example in which the vibration damper 2 is applied longitudinally on the panel member 1. Specifically, in the test sample resulting from the longitudinal application shown in FIG. 12, the vibration damper 2 is applied in the first direction D1 being the direction in which the vibration damper 2 is to be stretched or compressed in response to the application of the bending load to the panel member 1, and each of the protruding parts 11 is continuous in the first direction D1.

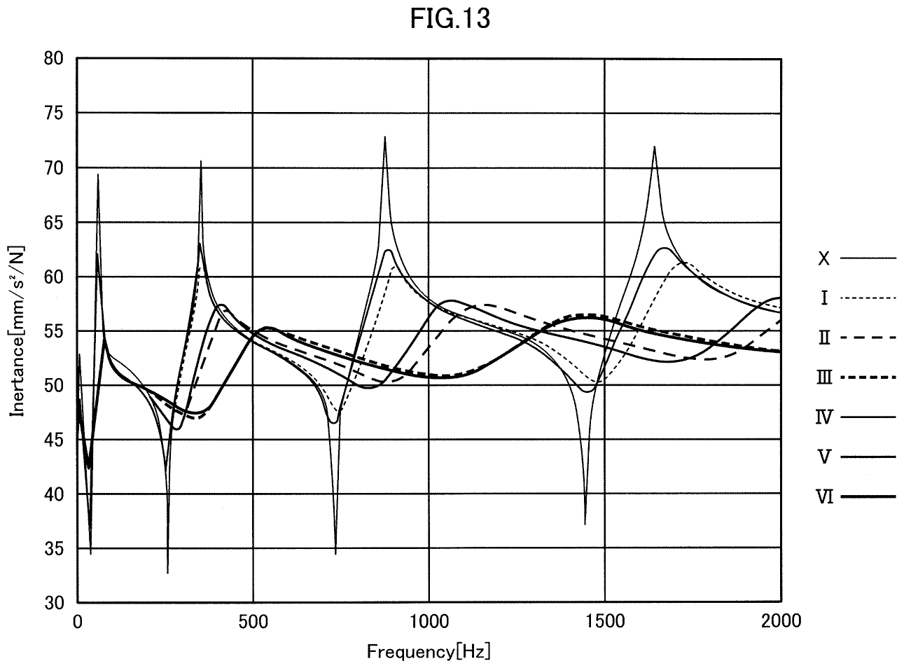

FIG. 13 is a graph showing a relationship between inertances (ratio of acceleration to force applied to an object) and frequencies of vibration waves due to vibration to vibration damping structure bodies in which the test sample as the example in FIG. 12 is combined with the structures I to VI in FIG. 3, and vibration to a structure X including the panel member 1 only.

The graph in FIG. 13 for a case where the vibration damper 2 is applied longitudinally on the panel member 1 shows that each of curves I to III indicative of inertances of structures as the examples in which one, two, or three layers of the vibration damper 2 and the restriction layer 3 are adhered and curves IV to VI indicative of inertances of structures as the comparative examples including one, two, or three layers of the vibration damper 2 only has a gentler peak than a curve X indicative of the inertance of the structure X including the panel member 1 only, resulting in a stronger effect of reducing the peak of the inertance.

The graph in FIG. 13 also shows that the peaks of the curves I to III indicative of the inertances of the structures as the examples including the vibration damper 2 and the restriction layer 3 are apparently lower than the peaks of the curves IV to VI indicative of the inertances of the structures as the comparative examples including the vibration damper 2 only without the restriction layer 3, which indicates that the restriction layer 3 greatly contributes to the enhancement of the vibration damping effect.

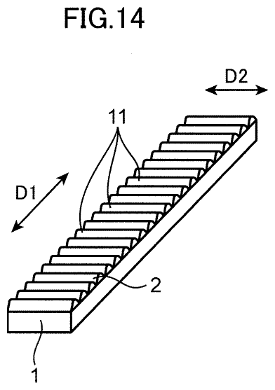

The vibration damping effect by a structure as a comparative example in which the vibration damper 2 is applied laterally on the panel member 1 as shown in FIG. 14 will be verified. In a test sample resulting from the lateral application shown in FIG. 14, the vibration damper 2 is applied in a second direction D2 orthogonal to the first direction D1 in which the vibration damper 2 is to be stretched or compressed in response to the application of the bending load to the panel member 1, and each of the protruding parts 11 is continuous in the second direction D2.

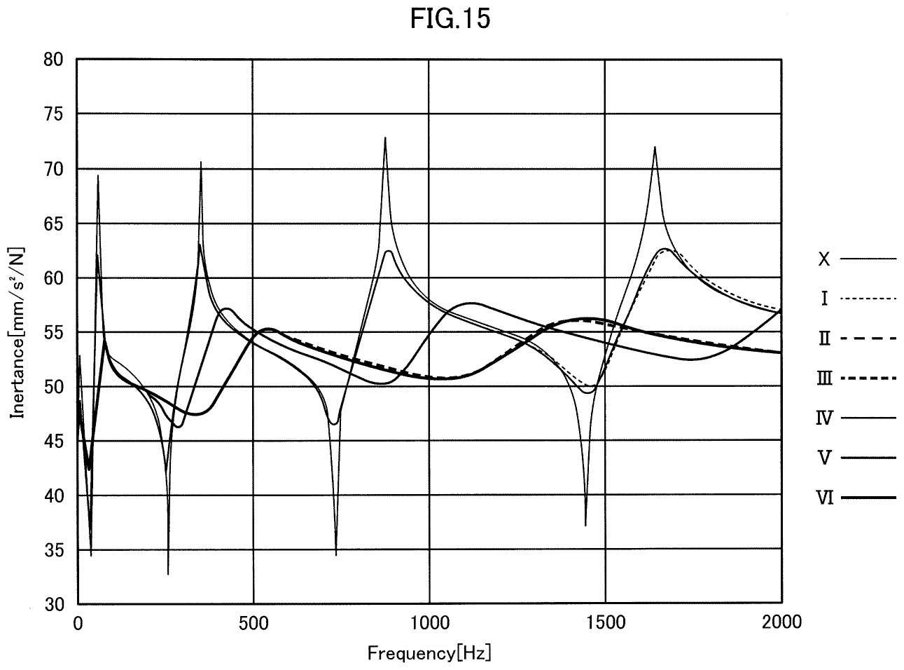

FIG. 15 is a graph showing a relationship between inertances and frequencies of vibration waves due to vibration to vibration damping structure bodies in which the test sample as the comparative example in FIG. 14 is combined with the structures I to VI in FIG. 3, and vibration to the structure X including the panel member only.

The graph in FIG. 15 for a case where the vibration damper 2 is applied laterally on the panel member 1 shows that each of curves I to III indicative of inertances of structures as the examples in which one, two, or three layers of the vibration damper 2 and the restriction layer 3 are adhered and curves IV to VI indicative of inertances of structures as the comparative examples including one, two, or three layers of the vibration damper 2 only does not have a very gentle peak, resulting in a weaker effect of reducing the peak of the inertance in comparison with the examples of the longitudinal application in the graph of FIG. 13. The graph in FIG. 15 also shows that the peaks of the curves I to III indicative of the inertances of the structures including the restriction layer 3 are not much lower than the peaks of the curves IV to VI indicative of the inertances of the structures as the comparative examples without the restriction layer 3, which indicates that the restriction layer 3 feebly contributes to the vibration damping effect.

A comparison between the graphs in FIGS. 13 and 15, which indicates that the peaks of the inertances of the curves I to III in FIG. 13 are much lower than the peaks of the curves I to III in FIG. 15, shows that the vibration damping effect of the test sample as the example shown in FIG. 12 in which the vibration damper 2 is applied longitudinally on the panel member 1 is stronger than that of the test sample as the comparative example of the lateral application shown in FIG. 14.

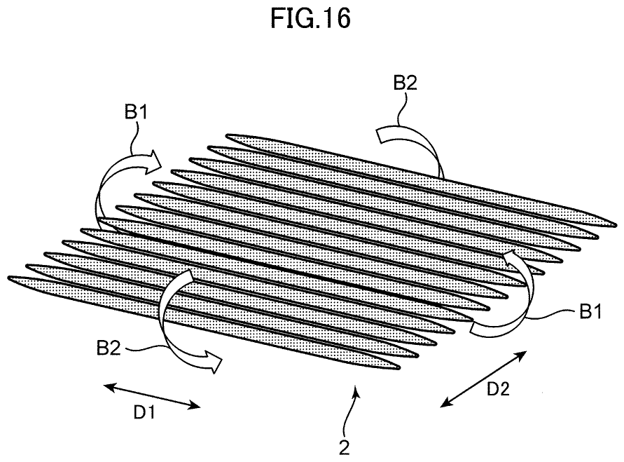

With reference to FIG. 16, the vibration damping effects of the longitudinally applied vibration damper 2 and the laterally applied vibration damper 2 will be further compared. A schematic model as shown in FIG. 16 indicates that the vibration damper 2 applied longitudinally with respect to a bending direction B1, i.e., the vibration damper 2 along the first direction D1 has a higher flexural rigidity in the bending direction B1, and has a stronger vibration damping effect. On the other hand, for a structure in which the vibration damper 2 is applied laterally with respect to a bending direction B2 (i.e., a structure in which the vibration damper 2 is applied in the first direction D1 orthogonal to the second direction D2 along the bending direction B2), the model indicates that the vibration damper 2 has a lower flexural rigidity in the bending direction B2, and has a weaker vibration damping effect.

### SUMMARY

The method for producing the vibration damping structure body described above in relation to the embodiment mainly includes the following features. A method according to the embodiment described above for producing a vibration damping structure body including: a panel member; a vibration damper made of a first resin to cure superficially and foam internally by heating and adhered to at least one surface of the panel member; a restriction layer that is made of a thermosetting second resin, less deformable than the vibration damper, and adhered to a surface of the opposite side of the vibration damper from the panel member, includes: a first step of providing the first resin on the at least one surface of the panel member; a second step of curing a surface of the first resin by heating; a third step of providing the second resin on the surface of the first resin; and a fourth step of heating the first resin and the second resin thereby curing the second resin to form the restriction layer and causing the first resin to foam internally to form the vibration damper.

In the producing method, in the second step, the surface of the first resin to be the vibration damper is cured by heating in advance; then, in the third step, the second resin to be the restriction layer is placed on the surface of the first resin to cover the surface of the first resin; and thereafter, in the fourth step, the first resin and the second resin are heated to form the vibration damper and the restriction layer.

Specifically, the internal foaming of the first resin is promoted by reheating the first resin in the fourth step after covering the surface of the first resin with the second resin in the third step, so that the coat thickness of the formed vibration damper can be increased. Thus, the vibration reducing effect by the vibration damping structure body can be enhanced without excessive increase in the production cost and the weight of the vibration damper.

In the method for producing the vibration damping structure body above, preferably, in the first step, two or more layers of the first resin are provided, and, in the third step, the second resin is provided on a surface of an uppermost layer of the first resin.

Thus, covering the surface of the outermost layer of the first resin with the second resin in the third step causes the heating of the first resin in the subsequent fourth step to promote the internal foaming of all the layers of the first resin, so that the coat thickness of the formed vibration damper can be increased. Thus, the coat thickness increasing effect can be exerted.

In the method for producing the vibration damping structure body above, preferably, in the first step, the first resin is applied to extend in shape of a strip so as to form a plurality of protruding parts on the surface of the first resin, in the second step, the protruding parts are cured by heating, and, in the third step, the second resin is applied to fit in a recessed part between protruding parts adjacent to each other.

In this configuration, in the first step and the second step, a plurality of protruding parts are formed and cured on the surface of the first resin to be the vibration damper. Then, in the third step, the second resin is applied to fit between the protruding parts, and subsequently, in the fourth step, the second resin is heated and cured to form the restriction layer, which restricts the protruding parts of the vibration damper. Thus, a restriction effect by the restriction layer on the vibration damper is enhanced, and the vibration damping effect is further enhanced.

In the method for producing the vibration damping structure body above, preferably, the panel member includes a floor panel that constitutes a floor of a vehicle and is fixed to a frame of a vehicle body, the frame extending in a vehicle longitudinal direction, and, in the first step, the first resin is applied on the floor panel in an intersection direction intersecting a vehicle longitudinal direction to form the protruding parts extending in the intersection direction.

The floor panel is fixed to the frame extending in the vehicle longitudinal direction. Thus, the floor panel has an enhanced flexural rigidity in the vehicle longitudinal direction due to a reinforcing effect by the frame. In contrast, flexural rigidity in the intersection direction intersecting the vehicle longitudinal direction, particularly in the vehicle width direction is low because the reinforcing effect by the frame is weak. Accordingly, the floor panel is most likely to be bent and deformed in the vehicle width direction when receiving external vibration.

Therefore, in the producing method above, the first resin is applied on the floor panel in an intersection direction intersecting the vehicle longitudinal direction to form the protruding parts extending in the intersection direction. The protruding parts that are continuous in the intersection direction are restricted by the restriction layer formed in the fourth step, so that the rigidity of the vibration damper can be enhanced, and the vibration damper can store strain energy. Consequently, the vibration damping effect can be enhanced.

In the method for producing the vibration damping structure body above, preferably, in the first step, the first resin is applied in a vehicle width direction perpendicularly intersecting the vehicle longitudinal direction to form the protruding parts extending in the vehicle width direction.

In the producing method, the first resin is applied in the vehicle width direction for which the flexural rigidity of the floor panel is the lowest to form the vibration damper having the protruding parts extending in the vehicle width direction. This enables the vibration damper to store higher strain energy. Consequently, the vibration damping effect can be further enhanced.

In the method for producing the vibration damping structure body above, preferably, the panel member includes a floor panel constituting a floor of a vehicle and having a curved part that is curved downward or upward from the floor panel, and, in the first step, the first resin is applied on the curved part.

In a case where the floor panel has a curved part that is curved downward or upward, the curved part has a lower flexural rigidity than a flat part of the floor panel. Therefore, the first resin is applied on the curved part of the floor panel with the lower flexural rigidity to form the vibration damper. Thus, the vibration damper having an enhanced rigidity due to the restriction of the protruding parts by the restriction layer as described above can store the strain energy. Consequently, the vibration damping effect can be enhanced.

In the method for producing the vibration damping structure body above, preferably, in the first step, the first resin is applied on a plurality of areas of the curved part spaced away from each other around a center of the curved part and extending radially in a centrifugal direction from the center in a view from one side along an up-down direction to form the protruding parts extending in the centrifugal direction.

The curved part has a particularly low flexural rigidity in a direction from the center thereof toward a periphery; therefore, the protruding parts extending in the centrifugal direction are formed as described above, so that the vibration damper can store higher strain energy. Consequently, the vibration damping effect can be further enhanced.

In the method for producing the vibration damping structure body above, preferably, the curved part includes a spare tire pan for housing a spare tire.

A spare tire pan having a diameter large enough to house a spare tire serves as the curved part. The spare tire pan has a particularly lower flexural rigidity than other parts of the floor panel. Therefore, the vibration damper is arranged on the spare tire pan, so that the vibration damper can store the strain energy. Consequently, the vibration damping effect in the spare tire pan can be enhanced.

In the method for producing the vibration damping structure body above, preferably, the floor panel is fixed to a plurality of cross members of a vehicle body that extend in a vehicle width direction and are spaced away from each other in a vehicle longitudinal direction, and the curved part is in a region of the floor panel between the cross members.

The region of the floor panel between the cross members, corresponding to the curved part, has a particularly low flexural rigidity. Therefore, the vibration damper is formed on the region, so that the vibration damper can store higher strain energy. Consequently, the vibration damping effect in the region of the floor panel between the cross members can be enhanced.

In the method for producing the vibration damping structure body above, preferably, in the first step, the first resin is applied on the region between the cross members in the vehicle width direction to form the protruding parts extending in the vehicle width direction.

In the producing method, the first resin is applied in the vehicle width direction on the region between the cross members, so that the vibration damper is adhered to the region to extend in the vehicle width direction and the protruding parts of the vibration damper are continuous in the vehicle width direction. Thus, the vibration damper can store still higher strain energy. Consequently, the vibration damping effect in the region between the cross members can be further enhanced.

In the method for producing the vibration damping structure body above, preferably, the second resin is made of clear coating material.

Use of clear coating material as the second resin enables conventional vehicle manufacturing equipment that performs clear coating to create the vibration damping structure body described above.

In the method for producing the vibration damping structure body above, preferably, in the fourth step, the first resin is heated at a temperature higher than a heating temperature in the second step.

In this configuration, a temperature for reheating the first resin in the fourth step is higher than the heating temperature in the second step, which ensures that the first resin foams internally and ensures increase in the coat thickness of the vibration damper.

As described above, the method for producing the vibration damping structure body according to the embodiment above can enhance the vibration damping effect while preventing excessive increase in the production cost and the weight of the vibration damper.

This application is based on Japanese Patent application No. 2024-104300 filed in Japan Patent Office on Jun. 27, 2024, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A method for producing a vibration damping structure body including: a panel member; a vibration damper made of a first resin to cure superficially and foam internally by heating, and adhered to at least one surface of the panel member; a restriction layer that is made of a thermosetting second resin, less deformable than the vibration damper, and adhered to a surface of the opposite side of the vibration damper from the panel member, the method comprising:
a first step of providing the first resin on the at least one surface of the panel member;
a second step of curing a surface of the first resin by heating;
a third step of providing the second resin on the surface of the first resin; and
a fourth step of heating the first resin and the second resin thereby curing the second resin to form the restriction layer and causing the first resin to foam internally to form the vibration damper.

2. The method for producing the vibration damping structure body according to claim 1, wherein,
in the first step, two or more layers of the first resin are provided, and
in the third step, the second resin is provided on a surface of an uppermost layer of the first resin.

3. The method for producing the vibration damping structure body according to claim 1, wherein,
in the first step, the first resin is applied to extend in shape of a strip so as to form a plurality of protruding parts on the surface of the first resin,
in the second step, the protruding parts are cured by heating, and,
in the third step, the second resin is applied to fit in a recessed part between protruding parts adjacent to each other.

4. The method for producing the vibration damping structure body according to claim 3, wherein
the panel member includes a floor panel that constitutes a floor of a vehicle and is fixed to a frame of a vehicle body, the frame extending in a vehicle longitudinal direction, and,
in the first step, the first resin is applied on the floor panel in an intersection direction intersecting the vehicle longitudinal direction to form the protruding parts extending in the intersection direction.

5. The method for producing the vibration damping structure body according to claim 4, wherein, in the first step, the first resin is applied in a vehicle width direction perpendicularly intersecting the vehicle longitudinal direction to form the protruding parts extending in the vehicle width direction.

6. The method for producing the vibration damping structure body according to claim 3, wherein
the panel member includes a floor panel constituting a floor of a vehicle and having a curved part that is curved downward or upward from the floor panel, and,
in the first step, the first resin is applied on the curved part.

7. The method for producing the vibration damping structure body according to claim 6, wherein, in the first step, the first resin is applied on a plurality of areas of the curved part spaced away from each other around a center of the curved part and extending radially in a centrifugal direction from the center in a view from one side along an up-down direction to form the protruding parts extending in the centrifugal direction.

8. The method for producing the vibration damping structure body according to claim 6, wherein the curved part includes a spare tire pan for housing a spare tire.

9. The method for producing the vibration damping structure body according to claim 6, wherein the floor panel is fixed to a plurality of cross members of a vehicle body that extend in a vehicle width direction and are spaced away from each other in a vehicle longitudinal direction, and
the curved part is in a region of the floor panel between the cross members.

10. The method for producing the vibration damping structure body according to claim 9, wherein, in the first step, the first resin is applied on the region between the cross members in the vehicle width direction to form the protruding parts extending in the vehicle width direction.

11. The method for producing the vibration damping structure body according to claim 1, wherein the second resin is made of clear coating material.

12. The method for producing the vibration damping structure body according to claim 1, wherein, in the fourth step, the first resin is heated at a temperature higher than a heating temperature in the second step.
